(19) United States
(12) Patent Application Publication
(10) Pub. No.: US 2003/0093809 A1
(43) Pub. Date: May 15, 2003

(54) Channel equalization

(76) Inventors: Zhengjin Shu, Fremont, CA (US); Thomas K. Paul, Santa Clara, CA (US); Norman C.H. Lo, Milpitas, CA (US); Muhammed Zia, Fremont, CA (US); Moe A. Lwin, San Jose, CA (US)

Correspondence Address: Omkar K. Suryadevara, SKJERVEN MORRILL MacPHERSON LLP, Suite 700, 25 Metro Drive, San Jose, CA, 95110-1349, US

(21) Appl. No.: 10/062,868

(22) Filed: Jan. 31, 2002

Related U.S. Application Data
(60) Provisional application No. 60/326,136, filed on Sep. 28, 2001.
(60) Provisional application No. 60/326,094, filed on Sep. 28, 2001.
(60) Provisional application No. 60/326,090, filed on Sep. 28, 2001.

(51) Int. Cl. H04N 7/173

(52) U.S. Cl. 725/111

(57) ABSTRACT

Channel equalization is performed by selecting an equalizer from a set of equalizers that have a common frequency response with the differences in the equalizers being able to be characterized by different values of a single variable. Selecting from a set of equalizers reduces the problem of training an equalizer to a one-dimensional optimization process. Specifically, the selection of the equalizer from the set is done through an optimization process in which a performance measure such as the signal-noise-ratio is maximized, or, as an alternative embodiment, some error measurements such as the power of the timing error signal is minimized. The set of equalizers may be generated from a root equalizer that has been already trained to compensate for a channel characteristic such that the set of equalizers all have the same frequency response, but have different group delays. In some embodiments, an equalizer trained in a previous training session and/or data session is used as the root equalizer for generation of the set of equalizers for a subsequent training and data session, thereby significantly shortening the equalizer convergence time and increasing the resulting signal-noise-ratio (SNR) of the receiver.

### CROSS-REFERENCE TO RELATED APPLICATIONS

This application claims priority from and incorporates by reference herein in their entirety, the following commonly owned co-pending provisional U.S. Patent Applications:

Serial No. 60/326136, entitled “Reuse of Learned Parameters in a Modem” filed by Chien-Cheng Tung, Thomas Paul, Gary Anwyl, Derek Obata and Zhengjin Shu on Sep. 28, 2001;

Serial No. 60/326094, entitled “Tuning and Reporting on Parameters and Algorithms in a Modem”, filed by Chien-Cheng Tung, Thomas Paul, Gary Anwyl and Derek Obata on Sep. 28, 2001; and

Serial No. 60/326090 entitled “Adaptive Modem”, filed by Zhengjin Shu, Chien-Cheng Tung, Thomas Paul, Gary Anwyl and Derek Obata on Sep. 28, 2001.

This application is also related to and incorporates by reference herein in their entirety, the following commonly owned co-pending nonprovisional U.S. patent applications:

Attorney Docket No. M-12267 US, entitled “Parameters for an Adaptive Modem” filed by Chien-Cheng Tung et al., filed concurrently herewith.

Ser. No. 09/967758, entitled “Interrupt Counter” filed by Long Wang on Sep. 28, 2001; and

Ser. No. 09/967750, entitled “Adaptive Buffer for Reducing Net Interface Latency” filed by Long Wang on Sep. 28, 2001.

### CROSS-REFERENCE TO SOFTWARE APPENDIX

Appendix A contains the following files in one CD-ROM (of which two identical copies are attached hereto), and is a part of the present disclosure and is incorporated by reference herein in its entirety:

| Volume in drive D is 020124_1717 | | | | |
|---|---|---|---|---|
| Volume Serial Number is F3C2-3D4D | | | | |
| Directory of D:/ | | | | |
| 01/24/02 | 05:17 p | <DIR> | | |
| 01/24/02 | 05:17 p | <DIR> | | |
| 01/23/02 | 10:09 a | | 28,937 | APMMAN˜1.C |
| 01/22/02 | 05:05 p | | 48,290 | SHU_R1˜1.C |

| | | |
|---|---|---|
| 4 File(s) | 77,227 | bytes |
| Total Files Listed: | | |
| 4 File(s) | 77,227 | bytes |
| | 0 | bytes free |

The files of Appendix A form source code of computer programs and related data of an illustrative embodiment of the present invention. These files contain source code for use in a Personal Computer (such as a PC available from Dell Corporation), running the Microsoft NT Operating System.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### FIELD OF THE INVENTION

The present invention relates to equalization of channel effects during data communication by either wire-line or wireless receivers.

### BACKGROUND

In an end-to-end communication link, a transmitter sends modulated signal waveforms that travel through a communication medium, which is referred to as the channel, before reaching a receiver at the receiving end of the communication link. The signal waveforms from the transmitter, after going through the channel, are changed in ways related to one or more characteristics of the channel. Such changes to the transmitted signal needs to be reversed to a certain extent by the receiver before effective detection of symbols transmitted by the transmitter can be achieved. The problem in receiver designs of reversing or removing the effect of a channel is referred to, in the prior art, as the problem of channel equalization.

Data communication normally consists of multiple repeating connections A-N (FIG. 1A) of a receiver with a transmitter, with each connection A in turn consisting of two sessions: a training session T and a data session D. During each training session, channel equalization is performed through adaptive filters that need to be trained to compensate for the effect of the channel. Such filters are referred to as channel equalizers, or equalizers for short, examples of which are shown in FIGS. 1B and 1C (described below). Apart from an equalizer, in a typical receiver there are additional functions that require a number of parameters (such as symbol timing and frequency offset) to be estimated in a training session, before transfer of user data (in a data session) can take place.

Therefore, in data communication over the public switched telephone network (PSTN), each connection between two modems includes a training session in which the two modems at the two ends of the telephone link learn, among other things, the channel characteristics by training the equalizer. After the training session, the connection goes into a data session whereby the actual user data are passed from one end to the other. The connection stays in a data session until either modem is instructed by the user to end the connection. At this point, knowledge about channel characteristics that was learned in the training session of the connection is typically lost. To re-establish a connection, the two modems go through, again, a training session before entering a data session.

As another example, in the wireless communication arena, each connection consists of a preamble session and a payload session. In the preamble session, the receiver is trained to learn, among other things, channel characteristics and symbol timing. Again, whatever the wireless modem learned in one preamble session is typically lost by the time of the next preamble session.

FIG. 1B shows a block diagram of a receiver that has a channel equalizer and a decision device. The coefficients of the channel equalizer are periodically adjusted so that on average the power of the error signal is minimized. In a training session, the error signal is the difference between the output of the equalizer and a reference training signal, while in a data session, the error signal is the difference between the output of the equalizer and that of the decision device.

FIG. 1C shows a block diagram of an alternative receiver that includes a decision feedback equalizer (DFE). In this case, the error signal is based on the difference between the output signal of the channel equalizer and that of the DFE. In effect, after the training session, the channel equalizer converges to a filter that reverses the effect of the channel on the transmitted signal. Such a filter is used to transfer data, in the data session.

In prior art modems, each connection is independent of a previous connection, i.e. no information is transferred therebetween. For example, equalizer coefficients learned in one training session are not normally used in the next training session, because the symbol timing changes from connection to connection making the previously learned equalizer coefficients unusable. In such prior art systems, training of a modem (including an equalizer) normally starts from scratch for each training session, using no knowledge from any of the previous training or data sessions.

However, certain prior art receivers may use knowledge from a previous connection, as described in, for example, U.S. Pat. No. 6,222,592 granted to Patel (which is incorporated by reference herein in its entirety as background). Patel states, in the abstract “An adaptive channel equalizer . . . includes memory for storing channel characterization information for each received channel, from each time the channel is tuned to until the next time the same channel is tuned to. . . . whenever a channel is tuned to again after having tuned to another channel, the previously stored channel characterization for the currently tuned channel is retrieved from memory. The retrieved channel characterization is used to calculate initial filter coefficients for the adaptive channel equalizer.”

See also U.S. Pat. Nos. 5,654,765, 5,648,987, 5,970,091, and 6,084,907, each of which is incorporated by reference herein in its entirety as background.

### SUMMARY

In accordance with the invention, channel equalization is achieved by selecting an equalizer from a suite of equalizers that all compensate the effect of a common channel. Specifically, the frequency response of a channel used in a previous connection (or the impulse response of a channel equalization filter used in the previous connection) can be used to generate channel equalizers in the suite. In several embodiments, the equalizers that are generated are “mature” in the sense that an adaptive equalizer has converged.

One of the equalizers in the suite is selected in some embodiments by a one-dimensional optimization process in a current connection, and the selected equalizer is thereafter used in receiver training and data transfer during the current connection. Although the one-dimensionsal optimization process may be used to optimize on any parameter depending on the embodiment, one embodiment selects an equalizer having a group delay appropriate for the current connection. As noted above, in several embodiments the selected equalizer is a “mature equalizer” that has already converged and may be used to receive data. In certain embodiments, the selected equalizer when selected during training session, is used in the training of other parameters of the receiver such as symbol timing and frequency offset.

Generation of a suite of equalizers, and selection from the suite as described above overcomes the divergence problem in using an equalizer trained in a previous connection (unaltered) in the current connection, in a receiver that performs digital timing recovery. Compared to an adaptive equalizer trained using convergence algorithms found in the prior art, generation of a suite of equalizers, and selection from the suite as described above improves performance of a receiver by, e.g. shortening the time required to identify an appropriate equalizer for the current connection which helps better estimate other parameters such as symbol timing and frequency offset, and further adjustment to the selected equalizer for improving the signal-noise-ratio (SNR) of the current connection.

Although the acts of generation and selection are used in combination with one another in certain embodiments, either act may be performed without the other act (i.e. generation can be performed without performing selection and vice versa). Specifically, in some embodiments generation of a suite is performed as described herein, and selection from the suite is performed in any conventional manner, and in other embodiments the opposite is true (i.e. generation is performed in any conventional manner and selection is performed as described herein).

In some embodiments, a suite of equalizers is generated from a single equalizer (also called “root equalizer”) that has been already trained (in a previous connection) to compensate for errors introduced by the channel. Such errors may be the result of frequency-selective attenuation, temporal distortion and/or multipath (introduced by the channel).

Depending on the embodiment, all equalizers in such a suite may have the same frequency response characteristics (e.g. frequency amplitude response, linear phase), but have different group delays. The group delays may span over several symbol-timing periods of the receiver, again depending on the embodiment. Selecting from a suite of equalizers having different group delays solves the problem of mismatch between symbol timing in the current connection and unaltered use of a previous connection's equalizer (e.g. the root equalizer), because a selected equalizer provides a better match. Mismatch between symbol timing of the current connection and the equalizer can cause the equalizer training process to diverge, delaying or even obstructing the eventual receipt of data by the receiver.

Selecting from a suite of equalizers reduces the prior art problem of training an equalizer into a one-dimensional optimization process. In certain embodiments, selection of an equalizer is done by an optimization process in which a performance measure such as the signal-noise-ratio is maximized, or, in an alternative embodiment, an error measurement such as the power of the timing error signal is minimized.

Although generation of a suite of equalizers and selecting an equalizer from the suite, as described above, has been performed during training in some embodiments, in other embodiments such acts are performed at other times. For example, in one embodiment, generation of the suite of equalizers is performed during a previous connection, and the selection is performed during the current connection. Moreover, in another embodiment, both the generation and the selection are performed during a data session, i.e. after an equalizer has converged in the normal manner using adaptive algorithms (by selecting an equalizer from the suite that has the closest group delay to the group delay of the converged equalizer). Furthermore, the acts of generation and selection may be performed any number of times during the connection, e.g. once during the training session, and another time during the data session, thereby to select the best equalizer in two stages. The parameters that are optimized in the two stages may be either different, or may be identical, depending on the embodiment.

### BRIEF DESCRIPTION OF THE DRAWINGS

FIG. 1A illustrates in a timing diagram a generic protocol used in the prior art, whereby each connection is divided into two sessions, a training session and a data session.

FIG. 1B shows a block diagram of portions of a receiver consisting of a channel equalizer and a decision device (prior art).

FIG. 1C shows a block diagram of portions of a receiver that, in addition to the channel equalizer and decision device shown in FIG. 1B, has a decision feedback equalizer (DFE) (also prior art).

FIG. 2A illustrates, in a flow chart, generation of a suite of channel equalizers and selection of an equalizer from the suite in a method in accordance with the invention.

FIGS. 2B and 2C illustrate, in flow charts, use of the acts of FIG. 2A in two embodiments.

FIG. 3A illustrates, in a flow chart, a method to implement the act of generation of FIG. 2A in one embodiment.

FIG. 3B illustrates, in a block diagram, a bank of filters through which are passed the coefficients of a root equalizer to generate an equalizer by the method of FIG. 3A.

FIG. 3C illustrates two graphs: the top graph is a timing chart illustrating the relation between group delay of each set of equalizer coefficients (representing an equalizer) relative to the root equalizer, and sampling period of the equalizer, and the bottom graph illustrates an index into a suite of such equalizers.

FIG. 3D illustrates, in a graph, a low-pass filter with the pass-band in the frequency range of 0-F_{BW} wherein F_{BW} is the signal bandwidth, and the stop band in the frequency range of F_{BW}-Fₛ/2 wherein Fₛ is the sampling frequency of the filter.

FIG. 3E illustrates, in a graph, construction of impulse responses of the N filters of the filter bank shown in FIG. 3B, based on the low pass filter of FIG. 3D.

FIG. 4A shows a top-level flow chart illustrating searching for the best equalizer, whereby the searching process includes a series of stages.

FIG. 4B shows a flow chart of a single stage indicated in FIG. 4A whereby the searching is through a subset of the N sets of equalizer coefficients and an equalizer coefficients set that produces the maximum SNR (or other performance index) is selected.

FIG. 4C is a flow chart of an alternative algorithm for searching for the best equalizer coefficient set where the searching is guided by either a gradient measure of a performance index or by a timing error signal.

FIG. 4D shows a block diagram depicting how a timing error signal can be derived from the outputs of the equalizer and the decision device that can be used in the equalizer search shown in FIG. 4C.

FIG. 5 shows a flow chart of one specific implementation in accordance with the invention.

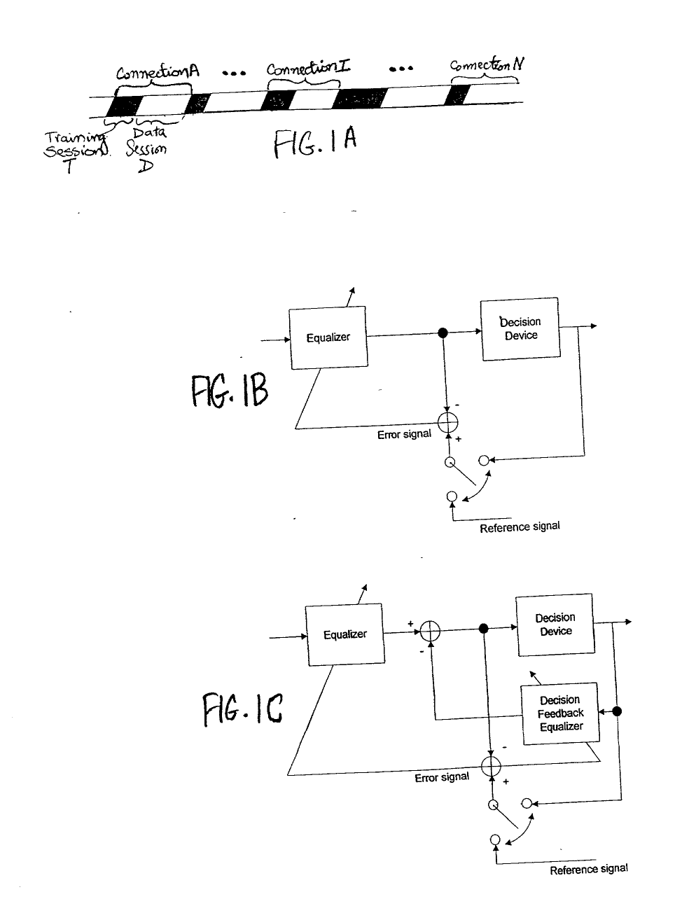

Various symbols in the above-described drawings denote the following.

| SYMBOLS | DESCRIPTIONS |
|---|---|
| N | The number of equalizers in a set; |
| | The number of filters used to |
| | generate the set of equalizers |
| h¹[n], h²[n], | Impulse responses of the set of |
| h³ [n], . . . , h^{N}[n] | filters used to generate the set |
| | of equalizers |
| c¹[n], c²[n], | N sets of equalizer coefficients |
| c³[n] . . . , c^{N}[n] | |
| c^{x}[n] | One particular set of equalizer |
| | coefficients, identifed as X^{th} set |
| Nₙ | Number of coefficients of an |
| | equalizer |
| c[n] | A root set of equalizer |
| | coefficients |
| EQ | Equalizer |
| N_{SP} | Number of index intervals that a |
| | sampling period of the equalizer |
| | spans, with the index being the |
| | set index of a set of equalizers |

### DETAILED DESCRIPTION

In accordance with the invention, the design of a receiver (that uses digital timing recovery) in a modem is simplified by assuming that certain aspects of a channel (such as the frequency amplitude response) remain the same (or very similar, e.g. less than 10% change) from connection to connection, e.g. if the same telephone number is being dialed via the same local loop. A receiver based on digital timing recovery may be implemented by an appropriately programmed Digital Signal Processor (DSP) or Central Processing Unit (CPU) of a Host Signal Processor (HSP) modem.

Digital timing recover may be implemented in a receiver in any manner well known in the art. For more information on digital timing recovery in a receiver, see, for example, the research project entitled “Design and Implementation of Digital Timing Recovery And Carrier Synchronization For High Speed Wireless Communication” by Paul James Husted, submitted to the Department of Electrical Engineering and Computer Sciences, University of California at Berkeley, available on the Internet at bwrc.eecs.berkeley.edu/Publications/2000/Theses/describe_implement_dig_tim_recovery/PaulMasters.pdf, which is incorporated by reference herein in its entirety.

Note that instead of the telephone number, line probing result or other information may be used to determine that the same channel is being used. Knowledge learned from a previous connection (such as the frequency amplitude response of the channel) may be used in a subsequent connection, to achieve better performance in that subsequent connection as compared to the prior art.

As noted elsewhere, there are changes in symbol timing from connection to connection. Therefore, an equalizer used in a previous connection is not used unaltered in the current connection. Instead, the previously used equalizer (also called “root equalizer”) is used in one embodiment to determine the frequency amplitude response of the channel. As used herein, the term frequency amplitude response is used to indicate the real valued portion of a complex valued function for the frequency response, and specifies the amplitude gain that a filter provides at each of a number of frequencies. As would be apparent to the skilled artisan, the frequency response may be decomposed into two real-valued functions, namely the amplitude response and the phase response (because every complex number can be represented by its magnitude and angle).

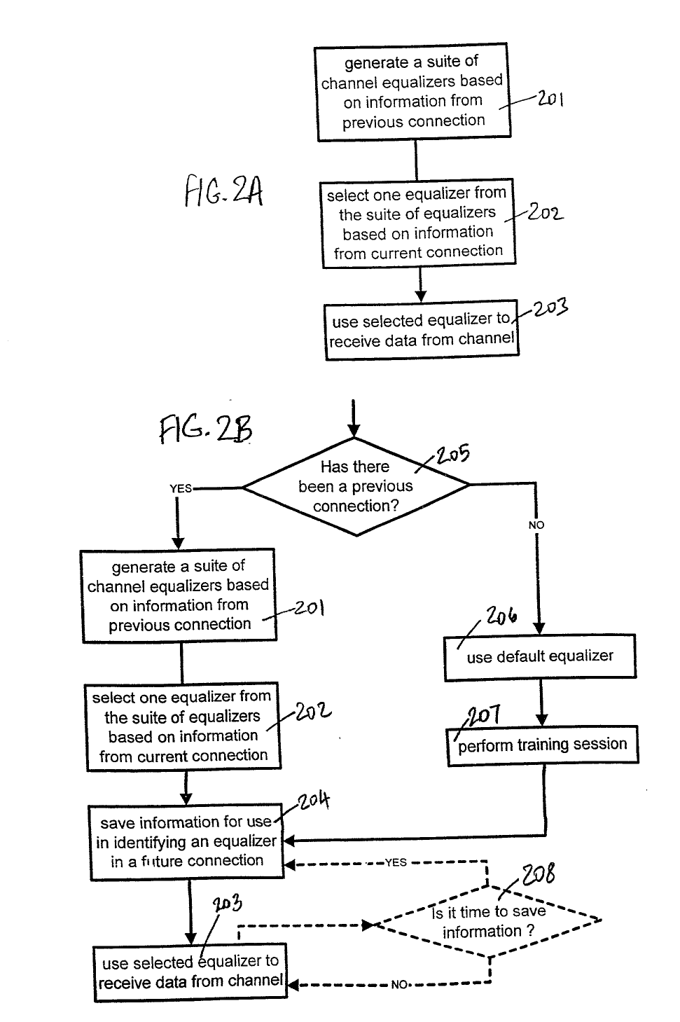

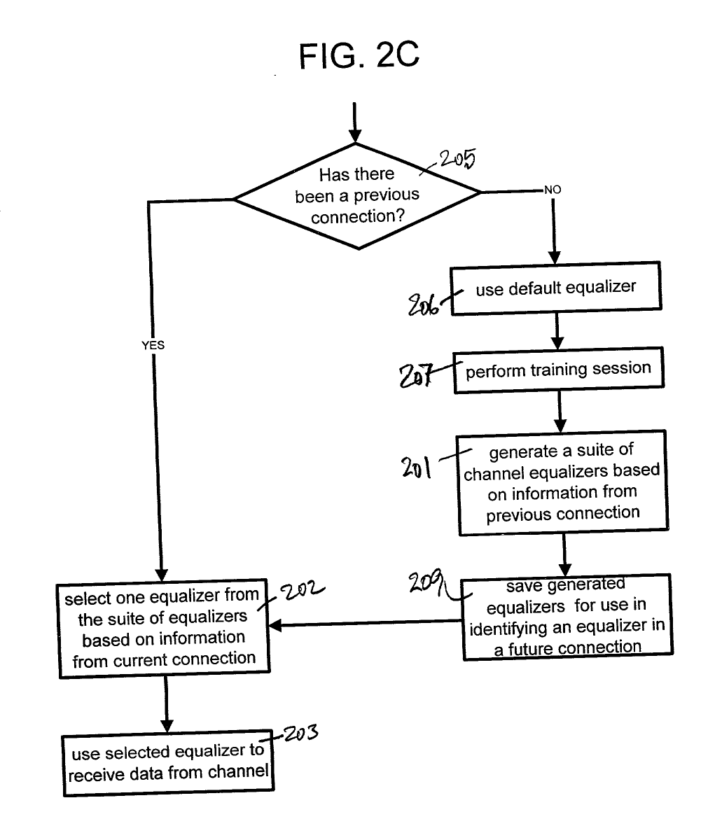

The frequency amplitude response in turn is used to generate a number of equalizers (as illustrated by act 201 in FIG. 2A). Depending on the embodiment, the root equalizer may or may not be included in the suite. There is nothing wrong to include the root equalizer in the suite. In the design illustrated in the attached Appendix A, we include it in the suite for convenience. Ideally, a suite can contain an infinite number of equalizers, to obtain a perfect matching between a selected equalizer and the symbol timing. In practice, the matching is close if not perfect. Thus, if the perfect timing in a new connection matches exactly with the root equalizer, and if the root equalizer is not in the suite, selecting the closest one should work. In fact, the root equalizer is nothing special in the suite for a new connection because the symbol timing will be randomly different from connection to connection. In some embodiments, each generated equalizer has a frequency amplitude response inverse of the channel's frequency amplitude response. Note that the generated equalizers may have frequency amplitude responses that differ from one another by a small amount (e.g. 1%).

In such embodiments, each generated equalizer may have a group delay different from another generated equalizer, so that a generated equalizer with an appropriate group delay may be selected for use in the current connection.

Therefore, in one embodiment, one of the generated equalizers from the suite, having a group delay required by the current connection is selected (as illustrated by act 202 in FIG. 2A) for use in data transfer (see act 203). Generation of multiple equalizers, each with a different group delay, solves the problem of mismatch between symbol timing and use of the root equalizer in the current connection.

Generation of channel equalizers may be performed either at the beginning of the current connection (as illustrated by act 201 in FIG. 2B) or during the previous connection and saved for use in future (as illustrated by act 209 in FIG. 2C), or at any time therebetween, depending on the embodiment. In the two embodiments illustrated in FIGS. 2B and 2C, a check is performed in act 205 as to whether or not there has been a previous connection, prior to act 201. If there was no previous connection, defaults set at the factory are used (as per act 206), and training is performed (as per act 207) in both embodiments.

In the embodiment of FIG. 2B, act 207 is followed by saving the information (as per act 204) which is also done between acts 202 and 203. Such information may be also saved periodically, as illustrated by act 208 (checking if it is time to save information).

In the alternative embodiment of FIG. 2C, act 207 is followed by act 201 (described above), followed by act 209 to save the generated equalizers for use in a future connection. In the alternative embodiment, if there was a previous connection as per act 205, act 202 is performed to select an equalizer from the suite of equalizers saved in act 209, followed by act 203 (described above).

Depending on the embodiment, selection of a channel equalizer in act 202 may be based on any information provided by the current connection, such as signal to noise ratio (commonly abbreviated as SNR), or timing error.

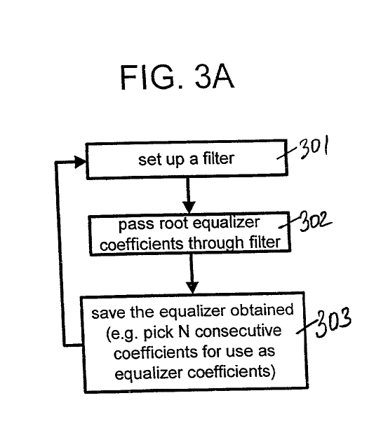

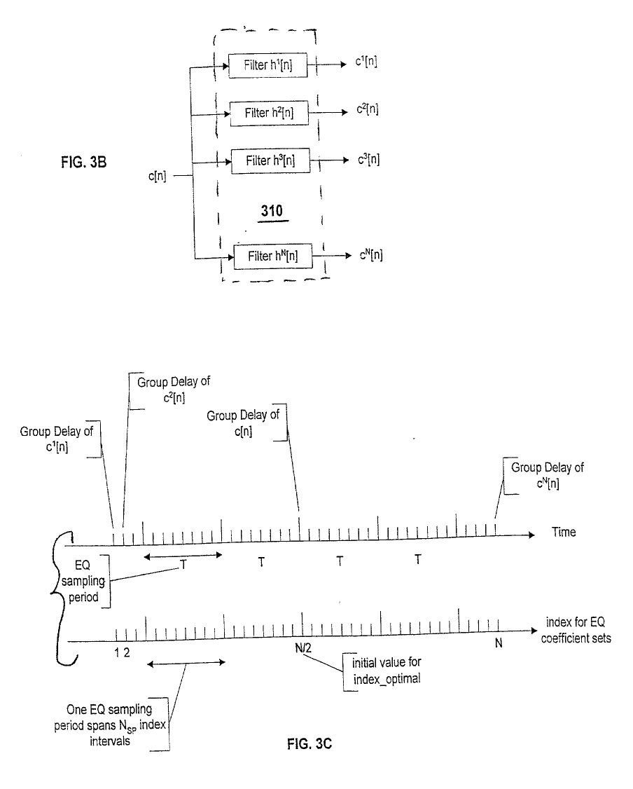

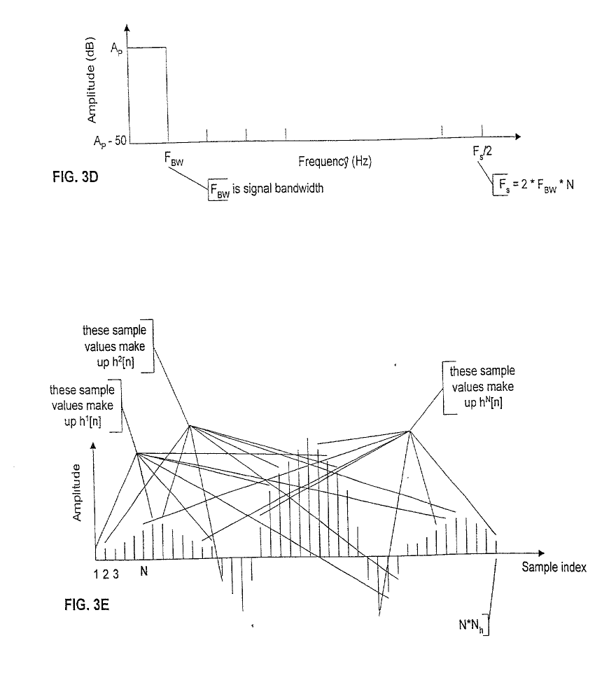

In one embodiment of the invention, each channel equalizer is represented by a set of coefficients. Other implementations use an algorithm to generate the set of coefficients, then the algorithm is used to represent the equalizer, or the equalizer may be represented in the frequency domain. Also, other embodiments use a set of numbers which are different from the set of coefficients that are usually defined in the time domain. In one embodiment, generation of a suite of equalizers is performed by repeatedly performing acts 301-303 (FIG. 3A). Specifically, a filter is set up (see act 301), followed by passing of coefficients through the filter (see act 302), and saving the coefficients obtained from the filter (see act 303) for use as one of the equalizers in the suite. Passing act 203 may be implemented, e.g. by a convolution operation performed by a CPU, as would be apparent to the skilled artisan in view of this disclosure.

As shown in FIG. 3B, from a single set c[n] of equalizer coefficients (e.g. from a past connection), which is hereafter referred to as the root set of coefficients, it is possible to derive a number N of sets c¹[n]-c^{N}[n] of coefficients, with each set c¹[n] having the same, or within a range DA_{FR} of each other, frequency response but different group delays.

The bottom scale in FIG. 3C shows an index in the range of 1-N which identifies each of the N equalizers in the suite, and the index indicates the group delay. As shown in FIG. 3C, the group delays of the N sets of equalizer coefficients span over several symbol timing periods (e.g. over two periods T) of the receiver.

Thus, although the root equalizer coefficient set c[n] is not used directly in a new connection, one of the equalizer coefficient sets c¹[n]-c^{N}[n] generated therefrom is used, depending on the symbol timing of the new connection. The design of the filter banks 310 (FIG. 3B) that are used to generate the N sets of the equalizer coefficients from the root set is illustrated in FIG. 3D and 3E (described later on below).

One embodiment generates a suite of N equalizers by passing a root equalizer through a set of N filters 310 shown in FIG. 3B. This set of N filters 310 maintains the frequency amplitude response of an input signal in the output signal within a limit (e.g. within 1% depending on the design of filters 310), but the output signal is delayed by a fixed amount of time (discussed below). This set of N filters 310 introduces a corresponding set of group delays in the root equalizer identified by coefficients c[n], to obtain a corresponding number of equalizers. In one embodiment, the equalizers obtained from the filters are delayed relative to one another by a fixed amount of time (e.g. a predetermined fraction of equalizer sampling period T, such as T/N) so that the N equalizers are uniformly spaced in the time domain as illustrated in FIG. 3C (e.g. one equalizer sampling period spans Nₛₚ index intervals).

The root equalizer coefficients c[n] are treated as samples of a signal that is passed through the filters 310 of FIG. 3B, to obtain another signal having samples. Nₙ consecutive samples (e.g. 96 samples) are picked, starting from a sample which is separated from the first sample by the duration of the filter's delay.

Such a suite of equalizers may be generated by use of a low pass filter 310 (FIG. 3B) which is initially designed by selecting its filter bandwidth F_{BW} same as the bandwidth of the signal to be sent through the channel (e.g. 4K for a voice-band modem). Moreover the sampling frequency Fₛ of the low pass filter is 2*F_{BW}*N. The frequency amplitude response of the low pass filter is selected to be ideally flat with a gain from 0 Hz up to F_{BW}, such that the N filters h¹[n]-h^{N}[n] in FIG. 3B all have 0 dB gain in their passband. This low pass filter has an impulse response of the type illustrated in FIG. 3D.

The impulse response of this low pass filter is used to construct (as shown in FIG. 3E, see bellow) the N filters of the filter bank shown in FIG. 3B. The gain Aₚ in the passband of this low-pass filter is designed such that the N filters constructed as shown in FIG. 3E should each has a passband gain of 0 dB. An example value of the stopband attenuation of this low-pass filter is 50 dB below the passband gain Aₚ. The graph's vertical axis is in logarithmic scale; the graph means the filter's gain in the band outside the passband region is minus infinity. In practice, although minus infinity is not possible, the requirement for the filter design is a predetermined amount of dB down from the passband gain. See the sampling frequency Fₛ relative to the signal bandwidth F_{BW}.

The impulse response of the above-described low pass filter is used to generate impulse response coefficients for the entire set of N filters shown in FIG. 3B. Specifically, in FIG. 3E, by picking one impulse response coefficient every N samples of the impulse response of the low pass filter (described above), a single set h¹[n] of impulse response coefficients (for a filter of the type shown in FIG. 3B) is formed. For a subsequent filter i+1 in FIG. 3B, one may start from a later starting sample (which is still one of the first N samples) in FIG. 3E, and pick an impulse response coefficient every N samples. This is a method of generating sub-sample shifting filters and is done only once for a receiver, and may be done ahead of time (e.g. manually during the design of this device).

One example has 96 coefficients for the root equalizer, although any number may be used. These 96 coefficients are samples filtered by each of the filters in FIG. 3B, to result (which is a convolution) in more than 96 samples (depending on the filter length). In this example, from among all 96 consecutive resulting samples, the first resulting sample is picked depending on the group delay of the filter (basically the delay introduced by the filter is removed). This is how the suite of equalizer coefficients c⁰[n]-c^{N}[n] is generated in one embodiment, from root equalizer coefficients c[n].

There are Nₙ (e.g. 96) coefficients in each equalizer, and therefore a search for the best equalizer could be performed in Nₙ dimensions. However, the search is reduced to a one-dimensional search in one embodiment, as follows. The suite of N equalizers that are generated are arranged in a specific order relative to the root equalizer, with the order of arrangement being indicated by a channel characteristic that is different for each equalizer. One example of the channel characteristic is group delay, although other channel characteristics, e.g. channel gain if the mismatch between the equalizer and the channel effect is the gain, may also be used. Therefore, the search is to find a group delay to be used for the current connection.

A suite of equalizers that could be used with a channel may contain any number N (e.g. 150) of equalizers. In one embodiment, the N equalizers are labeled with an index that corresponds to their group delay. Therefore searching through the suite is same as searching in just one dimension (along the group delay). Any method well known in the art for performing a one-dimensional search may be used.

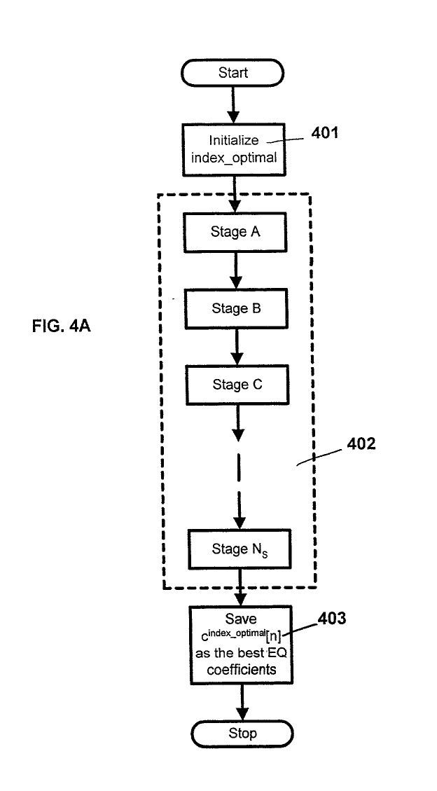

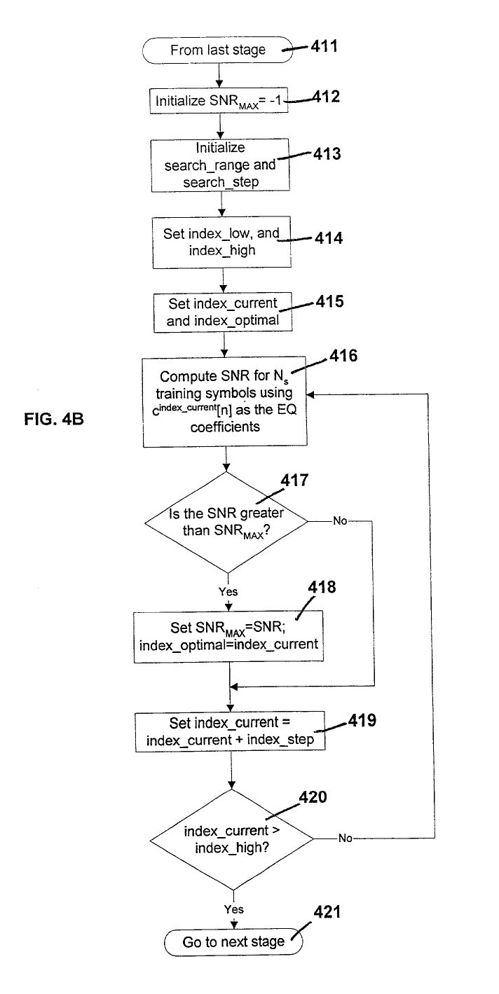

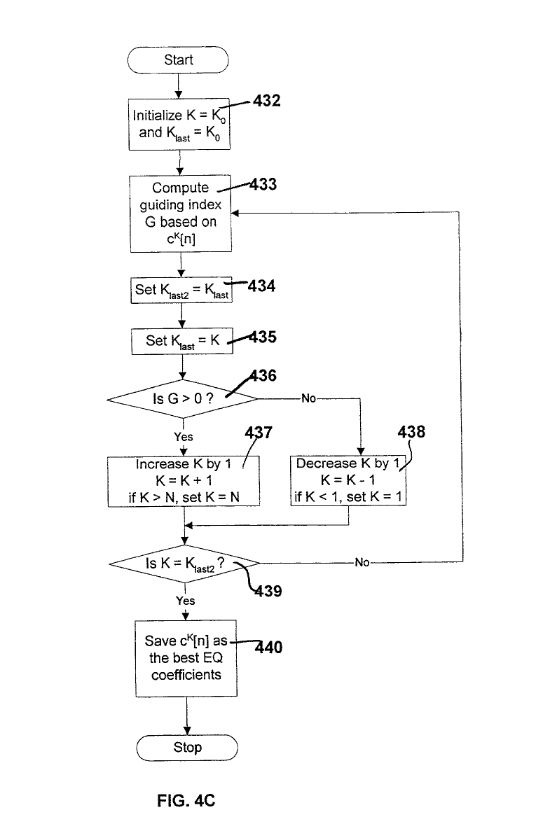

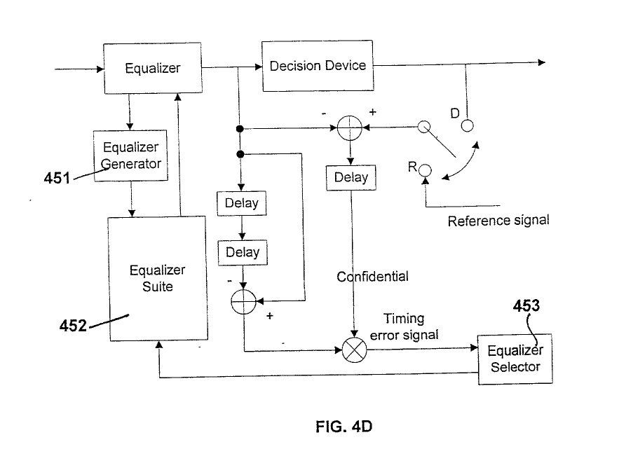

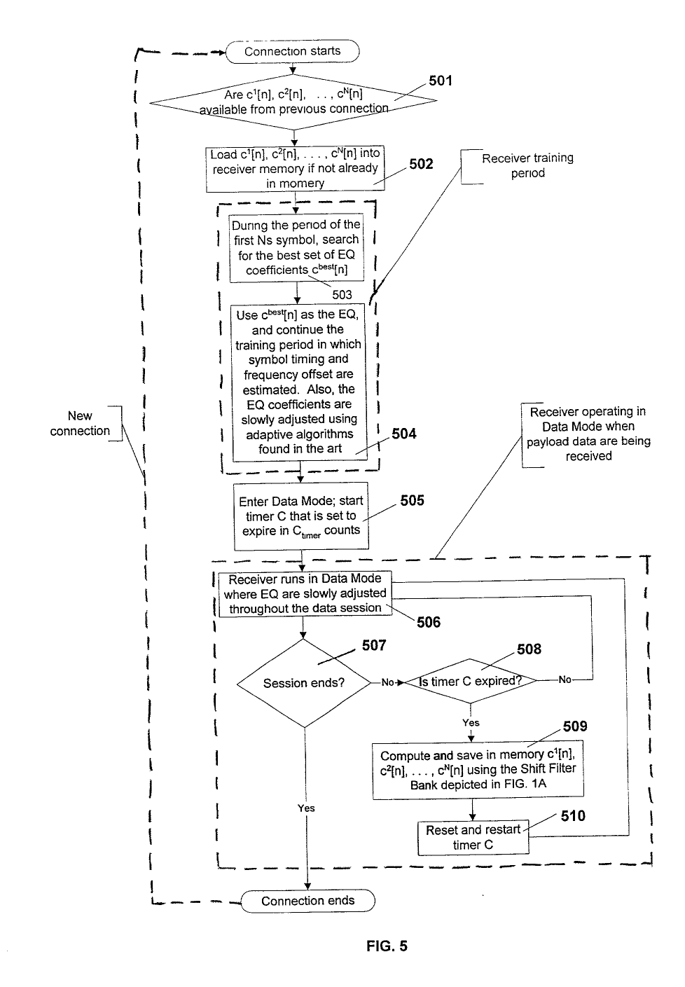

In one embodiment, an index into the suite of equalizers is initially selected (see act 401 in FIG. 4A) at the center of the suite (e.g. N/2 as illustrated in FIG. 3C). Then the search process goes through a number of stages (see operation 402 in FIG. 4A), and in each stage an identical set of acts are performed in one embodiment. After that, the search process saves (see act 403) the result which is the best index.

In an embodiment of the type illustrated in FIG. 4A, each stage picks a subset of equalizers from the entire suite of N equalizers, and finds the best equalizer in that subset (e.g. we find the index which provides the maximum SNR). The next stage picks a different subset based on the best equalizer identified in the previous stage. In the very first stage, equalizers for the subset to be searched are picked from across the entire suite, and are separated from one another by a number of equalizers that are skipped (i.e. not picked). In the very last stage, the equalizers that are picked for the subset are consecutively arranged in the suite (i.e. no equalizers are skipped).

The acts performed by each stage are illustrated in FIG. 4B, for one embodiment. In act 411 the current stage receives the identity of the equalizer used in the last stage (in one implementation, the equalizers are identified by an array of pointers, and we get the value of an index into the array). This identity is stored in a variable index_optimal, and is used to center the search range (as described below). As noted above, the very first stage starts with an equalizer in the middle of the suite.

In act 412, a variable SNR_{MAX} is initialized to −1 (a default value).

In act 413, each stage initializes a range for the search, and the range depends on the stage. The first stage picks the entire suite for searching, ranging from the lowest index to highest index (say 150). Also, the first stage picks K equalizers that are uniformly spaced in the above-described order (e.g. K may be 10 and K is selected to minimize the search time and at the same time effectively find the equalizer having the maximum SNR).

Subsequent stages pick a shorter range, so that each succeeding stage zooms in toward the best equalizer. The size of the range reduction at each stage is predetermined, and in one embodiment is set by experimentation. For example, the first stage may start with a range of 150 equalizers, then the second stage may use a range of 50 equalizers (centered around the best equalizer identified in the previous stage). Then the third stage may use a smaller range of 20 equalizers, and the last stage may use only 10 equalizers. Note that the last stage may evaluate each of the equalizers in its range consecutively.

In a similar manner each stage picks the step to be used during the search, and the step may reduce successively from stage to stage. An initial stage may start with a step of 15 initially, and this stage may evaluate 10 equalizers (if the range is 150 equalizers). In the second stage the step may be 8. In the third stage range is 20, and the step may be 4 (so we evaluate only 5 equalizers). In the last stage the range may be 8, and the step is 1 (so we evaluate all 8 equalizers). The last stage may take more time due to its evaluation of each stage, but has the advantage of thoroughness in covering the entire range.

In act 414, the stage sets variable index_low to be (index_optimal−search_range/2) and sets variable index_high to be (index_optimal+search_range/2). Initially the value of index_optimal comes from the previous stage, and we center our range of search around this value. In act 205 the stage sets variable index_current to same value as index low and also sets variable index optimal to same value as index_low (at the bottom of the search range).

Next, in act 416, the signal-to-noise-ratio (SNR) is calculated for a predetermined number Ns of training symbols. The number Ns is determined by experiment. If too few, then the SNR is not stable (too much noise—not stable), and if too many, then the SNR doesn't change. So SNR is the same for 16 symbols and 100 symbols. So one embodiment uses the smallest number that takes a reasonable amount of time. If the current SNR for the current index is greater than SNR_{MAX} (initially −1), then the method goes to act 418, and the optimal index is set to the current index, and optimal SNR is set to the current SNR. Act 419 calculates the next index, and if that index falls outside the range (as per act 420), the current stage is completed (and the search process goes to the next stage as per act 421), else the above-described acts 416-420 are repeated (by going back to act 416).

In act 416, the SNR is computed in each stage even if an equalizer is visited previously, in a first embodiment. A second embodiment is identical to the first embodiment except that the second last stage evaluates every other equalizer. In the second embodiment, the last stage evaluates only the equalizers that were not previously evaluated. In the second embodiment, the SNR is not initialized in the last stage, but kept from the previous stage and reused. Although implemented as second last stage and last stage, in this second embodiment, their combined effect is of only one stage, with a step of one.

Depending on the embodiment, in the last stage the search process may compute SNR only for equalizer on the right and left of the current equalizer, because these were not computed. In some embodiments, the search process may go a little further down, so there is a smaller range, but the search process preserves information from previous stage. If the SNR is previously computed, it may be saved and re-used in the next stage. A wider range is used in the last stage, because there may be local peaks for SNR due to noise, and the search process needs to find the biggest peak.

In one embodiment, SNR is used as the performance index, and a one-dimensional search is performed in an iterative manner as described above. In other embodiments, even a binary search (search one half of the range first, then cut range in half and repeat) may be used although the binary search may get stuck in the wrong half if there was some noise which directs the search process into the wrong half. So, any optimization process may be used to find SNR.

Another way to search for a best equalizer from among a suite of equalizers is illustrated in FIG. 4C. This search process starts at one end of the range (as per act 432), and computes a gradient G of the performance index (as per act 433). Thereafter, the search process finds the maxima in a performance measure by going in a direction of increasing index if the gradient is greater than zero (as per acts 436 and 437) and if not going in the opposite direction (as per act 438). For example, a search process may obtain the derivative G of SNR versus group delay. This derivative G is used to guide the search (to go uphill to a maxima or to go downhill to a minima, depending on the performance measure).

Note however, that instead of a gradient, a timing error signal can guide a search process as illustrated in FIG. 4D. The timing error signal provides a measure of timing error, and indicates to an equalizer selector 453 the direction in which search is to proceed to find an equalizer with better SNR. The timing error signal may be generated in any manner well known in the prior art. Depending on whether the timing error is positive or negative, the equalizer selector 453 looks for a better equalizer in opposite directions (among the equalizer suite 452), working to minimize the timing error. For example, if the timing error is greater than zero, the index is increased (or the other way around depending on the order in which the equalizers are arranged).

The just-described search may be speeded up by using a greater step in the direction indicated by the timing error signal. If the search process overshoots in one direction, the step is reduced and the search process goes back in the other direction. Such a search process may repeatedly zigzag in opposite directions (with successively smaller steps). When the step becomes one and the search process is alternately identifying the same equalizers, then the best equalizer has been identified.

A timing error signal used to drive equalizer selector 453 (FIG. 4D) may be generated as follows. Two samples are continually saved as they come in. The difference between a current sample and the 2^{nd} previous sample is multiplied by the difference between the current sample and the output of the decision device, to obtain the timing error signal. As noted above, there are many other ways of determining the timing error signal, and any method used in a prior art modem may be used to guide the one-dimensional search.

In one embodiment, when a new connection starts, a modem (which may be, for example, a HSP modem) checks in act 501 (FIG. 5) whether coefficients for a suite of equalizers are available (e.g. because they were saved in a previous connection). If so, these coefficients are loaded into memory (in act 502), if they were not already in memory.

Next, during a training session, while receiving the first Ns symbols, the best set of equalizer coefficients for use in the current connection are identified, as per act 503 (FIG. 5). In one implementation of act 503, a number of channel equalizers (each represented by a set of coefficients) are generated (in any manner apparent to the skilled artisan in view of the above description), and one of the generated channel equalizers is selected (also in any manner apparent to the skilled artisan in view of the above description). Depending on the embodiment, each of the generated equalizers may have an amplitude frequency response identical, or within a predetermined range, to the equalizer loaded into memory in act 502. Also depending on the embodiment, each of the generated equalizers may have linear phase frequency response and have a group delay different from all other generated equalizers.

Thereafter, while still in the training session, the selected equalizer is used (as illustrated by act 504), for further training of the modem, wherein other parameters such as symbol timing and frequency offset as well as the selected equalizer's coefficients are iteratively adjusted by use of an adaptive filtering method well known in the art (see e.g. Adaptive Signal Processing by Bernard Widrow and Samuel D. Stearns published by Prentice-Hall in 1985.).

Next, the modem enters a data session (as per act 505), and also starts a timer that is set to expire after a predetermined amount of time, namely Cₜᵢₘₑᵣ counts (e.g. 5 minutes). Values for Cₜᵢₘₑᵣ may be selected based the average minimum time for modems to stay connected, or by observing the how long does it take for the SNR to increase by a given amount (e.g. 1 dB). Thereafter, the modem operates in data mode, and receipt of user data occurs (as per act 506) based on the selected equalizer (adjusted as per act 504). Thereafter, if the session has not ended (as per act 507), the timer C is checked for expiration. If the timer C has not expired, the modem continues to receive user data (as per act 506). If the timer has expired in act 508, the coefficients for a suite of equalizers are generated and saved (as per act 509), and the timer is reset and restarted (as per act 510). Thereafter, the modem returns to receiving data (as per act 506).

Numerous modifications and adaptations of the embodiments described herein will be apparent to the skilled artisan in view of the disclosure. Specifically, in various embodiments of the invention, various kinds of information from a current connection may be used in the next connection. Values of parameters learned in one training session are not used unaltered in the next training session. Instead, certain information, such as a channel's frequency amplitude response is derived from equalizer coefficients resulting from a previous training session, and this derived information is used to identify another set of equalizer coefficients, thereby to shorten the current training session and increase the SNR of the current connection.

Certain embodiments first let the modem run through the training session and into the data session as it does normally without searching through the suite of equalizer yet. Then during data session, the equalizer converges into a set of coefficients using adaptive algorithms as seen in the art. Then, the group delay of this converged equalizer is computed. Then the equalizer from the suite that has the closest group delay to that of the converged equalizer is selected and used for further data reception. By doing this, an immediately increased SNR is achieved after the selection and that increase the noise margin of the connection which in turn increase the stability of the connection.

Computation for passing the root equalizer through multiple sets of filters to generate the suite of equalizers consumes power of a central processing unit (CPU) in the case of an HSP modem and so it is better to spread the computation over a period of time such that the peak CPU usage is not high enough to affect the normal operation of the modem.

The act of selecting in some embodiments assumes the equalizer is ready for use. In other embodiments, during the process of search for best equalizer, the equalizers are generated “on-demand”. In several embodiments, the CPU first generates an equalizer by passing the root equalizer through the corresponding filter before the SNR is computed. This way, memory usage is less, but CPU usage during the selection process is more. Other embodiments make a different trade-off between memory and CPU loading.

Numerous such modifications and adaptations of the embodiments described herein are encompassed by the attached claims.

1. A method of data communication, the method comprising:
selecting a channel equalizer (hereinafter “selected equalizer”) from a predetermined suite of channel equalizers; and
receiving data or training to receive data using the selected equalizer.

2. The method of claim 1 wherein:
each channel equalizer in the predetermined suite has a group delay different from another channel equalizer in the predetermined suite.

3. The method of claim 1 wherein:
each channel equalizer in the predetermined suite is represented by a set of coefficients.

4. The method of claim 3 further comprising:
for at least a plurality of channel equalizers in the predetermined suite, deriving corresponding sets of coefficients based on frequency amplitude response of a channel of a previous connection.

5. The method of claim 4 further comprising:
retrieving from memory a set of coefficients of a channel equalizer (hereinafter “root equalizer”) used to receive data prior to said selecting and said receiving;
using the set of coefficients of the root equalizer during said deriving; and
storing in memory the set of coefficients representing the selected equalizer, for use as a root equalizer in future deriving.

6. The method of claim 1 wherein:
the act of selecting is performed during a training session prior to receipt of the data.

7. The method of claim 1 wherein:
the act of selecting is performed during receipt of the data, wherein the selected equalizer in the suite has the closest group delay to that of the equalizer being used during the receipt of data but prior to the act of selecting.

8. The method of claim 1 wherein:
the act of selecting includes using a performance measure indicative of performance of the selected equalizer relative to performance of another equalizer in the predetermined suite.

9. The method of claim 8 further comprising, during the act of selecting:
searching for the channel equalizer having the best performance measure, from among all channel equalizers in the predetermined suite; and
identifying the channel equalizer having the best performance measure as the selected equalizer.

10. The method of claim 8 wherein an iterative process is used, during the act of selecting, and the iterative process comprises:
identifying in a current iteration an equalizer having a better performance measure than in a previous iteration unless the current iteration is a first iteration; and
identifying in a last iteration, the selected equalizer as the channel equalizer having the best performance measure.

11. The method of claim 1 wherein channel equalizers in the predetermined suite are arranged in an order of group delay indicated by an index, and the act of selecting comprises:
using a timing error signal to identify a value of the index indicative of the selected equalizer.

12. The method of claim 11 wherein the act of selecting comprises:
using an iterative process until no new selections are generated.

13. The method of claim 1 wherein channel equalizers in the predetermined suite are arranged in an order of group delay indicated by an index, and the act of selecting comprises:
using a gradient of performance measure over the index, to identify a value of the index indicative of the selected equalizer.

14. The method of claim 13 wherein the act of selecting comprises:
using an iterative process until either the gradient of performance measure falls within a predetermined limit or no new selections are generated.

15. The method of claim 1 further comprising:
adjusting the selected equalizer using an adaptive process.

16. The method of claim 15 further comprising:
storing in memory coefficients of the selected equalizer after adjusting, for use in future as a root equalizer.

17. The method of claim 15 wherein:
the act of adjusting is performed throughout training and operation sessions.

18. The method of claim 17 further comprising:
repeatedly storing in memory coefficients of the selected equalizer after adjusting, throughout training and operation sessions.

19. A method of generating a plurality of coefficients indicative of a plurality of channel equalizers, the method comprising:
retrieving from memory a channel equalizer (hereinafter “root equalizer”);
passing the root equalizer through a plurality of sets of filters to generate a corresponding plurality of channel equalizers;
wherein each set of filters maintains, within a limit, the frequency response of an input signal in the output signal, and each set of filters introduces a group delay different from another set of filters.

20. The method of claim 19 wherein:
the group delays of the plurality of channel equalizers are distributed within a range defined by a common sampling period of the channel equalizers.

21. The method of claim 19 further comprising, prior to said retrieving and said passing:
determining coefficients of the root equalizer during a training session.

22. The method of claim 19 further comprising, prior to said retrieving and said passing:
determining coefficients of the root equalizer during a data session.

23. The method of claim 19 wherein:
the root equalizer is predetermined based on channel characteristics.

24. The method of claim 19 wherein:
the act of passing is performed over a period of time while a receiver is in training or in operation.

25. The method of claim 19 further comprising:
selecting a channel equalizer from the plurality of channel equalizers for use in receiving data;
wherein the act of passing is performed in real time during the act of selecting.

26. A method of data communication, the method comprising:
generating a plurality of channel equalizers;
selecting a channel equalizer (hereinafter “selected equalizer”) from the plurality; and
receiving data, or training to receive data, using the selected equalizer.

27. The method of claim 26 wherein:
each channel equalizer in the plurality has an amplitude frequency response identical, within a limit, to another channel equalizer in the plurality.

28. The method of claim 26 wherein:
each channel equalizer in the plurality has a group delay different from another channel equalizer in the plurality.

29. A modem comprising:
an equalizer generator;
a memory encoded with a suite of equalizers coupled to receive a plurality of coefficients for each equalizer in the suite from the equalizer generator; and
an equalizer selector coupled to said memory to identify an equalizer in said suite, based on a signal derived from a channel of a current connection.

30. The modem of claim 29 wherein the equalizer selector implements a one-dimensionsal optimization process.
